(19) United States
(12) Patent Application Publication
(10) Pub. No.: US 2008/0050482 A1
(43) Pub. Date: Feb. 28, 2008

(54) Kit for and method of marinating uncooked food

(75) Inventors: John Fereghetti, Grand Blanc, MI (US); John Biafore JR., Grand Blanc, MI (US)

Correspondence Address: CARRIER BLACKMAN AND ASSOCIATES, 24101 NOVI ROAD, SUITE 100, NOVI, MI, 48375, US

(73) Assignee: Eastman Outdoors, Inc., Flushing, MI (US)

(21) Appl. No.: 11/811,883

(22) Filed: Jun. 12, 2007

Related U.S. Application Data
(60) Provisional application No. 60/813,241, filed on Jun. 13, 2006.

(51) Int. Cl. A23L 1/48; B65D 81/20

(52) U.S. Cl. 426/281; 99/472

(57) ABSTRACT

A method and kit is usable to marinate and tenderize food in a reduced-pressure environment. The kit includes a foraminous shell in which the food is placed, and a sealable bag in which the food, shell and marinade are placed. A vacuum pump and bag sealer are then used to create and maintain a reduced-pressure environment, creating voids within the food. While the reduced-pressure environment is maintained within the bag during a soak period, the user may vibrate, rotate, refrigerate, shake, or tumble the bag with the food and shell therein. During soaking and upon pressure equalization when the bag is opened, the marinade is drawn into the voids, thereby reducing the amount of time needed to marinate and tenderize foods. After removing the food from the shell and bag, the food may be stored, cooked or served. The foraminous shell is durable, washable, and re-usable.

### CROSS-REFERENCE TO RELATED APPLICATIONS

The present invention claims priority under 35 USC 119(e) based on U.S. provisional patent application No. 60/813,241, filed on Jun. 13, 2006. The subject matter of this priority document is incorporated by reference herein.

### BACKGROUND OF THE INVENTION

1. Field of the Invention

The present invention relates to a kit for, and to a method of marinating food in preparation for cooking same. More particularly, the present invention relates to a kit for, and a method of marinating uncooked food in a reduced-pressure environment, in which the food is placed in a plastic bag with a marinade, is encased in a foraminous shell disposed within the bag, air is evacuated from the bag, the bag is sealed, and the food is allowed to soak in the marinade for a period of time.

2. Description of the Background Art

A number of different devices are known for use in marinating food.

People have long tried to improve the taste and tenderness of foodstuff products. A variety of techniques have been used. Salt, wine, oil, and a combination of herbs and vegetables have been used to make foodstuff products easier to chew and better tasting. Chefs have known for many years that marinating foodstuff and fish improves the flavor and texture thereof.

Myosin is the most common protein found in muscle, a primary content of meat-based foodstuff products. Myosin acts as a binding agent to keep the muscle tissue of the meat together. The presence of too much myosin in meat tends to make the meat excessively tough and difficult to chew. Therefore, reducing the amount of myosin in meat will make it more tender, and is therefore desired.

One known method for reducing the amount of myosin in meat involves tumbling the meat in a drum. The drum contains internal paddles to cause the foodstuff to continually rotate and tumble.

This type of known foodstuff tumbler has some drawbacks. One drawback of most currently known foodstuff tumblers is that the sheer size of the tumbler makes it impractical for home use. These tumblers are built primarily for the commercial market, where large amounts of foodstuff are processed on a regular basis. Also, the tumbling action and the motor required to rotate the drum creates noise, which is undesirable in a home kitchen setting.

It has been known to marinate foodstuff and other food products, in a reduced-pressure environment, in some of the commercially available tumblers. For example, U.S. Pat. No. 7,007,594 to Thornton et al. suggests the use of a vacuum tumbler dimensioned to fit on a countertop, in which food may be marinated while it is tumbled in a vacuum.

It has been found that tenderizing of foodstuff products is accelerated when the products are placed in a vacuum-sealed container. This development, when applied to the large commercial tumblers described above, does not make them any more practical for home kitchen use.

U.S. Pat. Nos. 7,047,874 and 7,047,875 relate to a food tumbler apparatus configured and dimensioned to fit on a countertop, the apparatus including a canister, and a base for rotating the canister after air has been removed therefrom.

Other US patents relating generally to apparatus and methods for marinating foodstuffs include U.S. Pat. Nos. 2,742,367, 4,265,766, 4,716,824, 4,818,550, 4,867,995, 5,057,332 and 6,743,451.

### SUMMARY OF THE INVENTION

The present invention provides a simplified and low-cost kit and method for use in marinating food prior to cooking. The compact size of the apparatus according to the present invention makes its storage easy, because the apparatus only requires a small space in storage units. The relative price of this invention is significantly less than the cost of comparable equipment used for marinating foods, making the invention more widely available to the regular consuming public.

It has now been discovered that it is possible to obtain beneficial accelerated marinating of uncooked foodstuffs, without requiring a step of tumbling the foodstuff in a rotating drum.

In one embodiment thereof, the present invention provides a kit for use in marinating one or more uncooked food items, the kit including a foraminous shell, and a supply of sealable plastic bags. The shell may be formed from metal or a relatively strong plastic. The shell may be in the shape of a flattened cylinder open at the ends. Alternatively, the shell may be formed in a hinged clamshell shape, or in the shape of a wire-mesh box. Optionally, the kit may additionally include a bag sealing apparatus and/or a vacuum pump for removing air from the bag after the foodstuff and shell are placed therein.

In an illustrative method of marinating a foodstuff according to a first aspect of a method according to the present invention, the foodstuff is placed inside of a foraminous shell, and the shell is then placed into a strong plastic bag, along with a liquid marinade. Air is then removed from the bag using a vacuum pump, causing the bag to collapse around the foraminous shell, and the bag is sealed to retain a partial vacuum therein. This provides a reduced-pressure environment, but still retains some space around the foodstuff to allow the marinade to circulate.

The foodstuff may then be refrigerated as needed, and is allowed to remain in the bag in the reduced-pressure environment during a soak period, which may last for a time ranging from 10 minutes to several hours or overnight. A normal soak period may be in a range from 10 minutes to 4 hours. If the soak period is overnight, then the infusion of the marinade into the foodstuff will be more complete and the cooked foodstuff will be more flavorful than the results obtained from a marinade treatment which is carried out under normal atmospheric pressure.

After the soak period is over, the bag is then opened up, the foodstuff is removed from the bag and cooked, and the used bag is discarded. The shell may be washed and re-used, as needed.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a flow chart showing a series of steps in a method of marinating food according to an illustrative embodiment of a method according to the present invention.

FIG. 2 is a perspective view of a foraminous shell according to a first illustrative embodiment hereof, in which the food may be placed before the marinating method is begun. The shell according to this first embodiment has a compressed cylindrical shape with an elliptical cross-section, and is provided with porous walls to allow circulation of marinade.

FIG. 3 is a perspective view of a foraminous shell according to a second illustrative embodiment hereof.

FIG. 4 is a perspective view of a foraminous shell according to a third illustrative embodiment hereof.

FIG. 5 is a diagram of a bag usable in the kit and method hereof; and

FIG. 6 is a simplified schematic diagram showing components of a food marinating kit according to another embodiment of the present invention.

### DETAILED DESCRIPTION

It should be understood that only structures considered necessary for clarifying the present invention are described herein. Other conventional structures, and those of ancillary and auxiliary components of the system, are assumed to be known and understood by those skilled in the art.

As previously noted, the present invention provides a simplified and low-cost kit and method for use in marinating food prior to cooking.

Method of Marinating Food

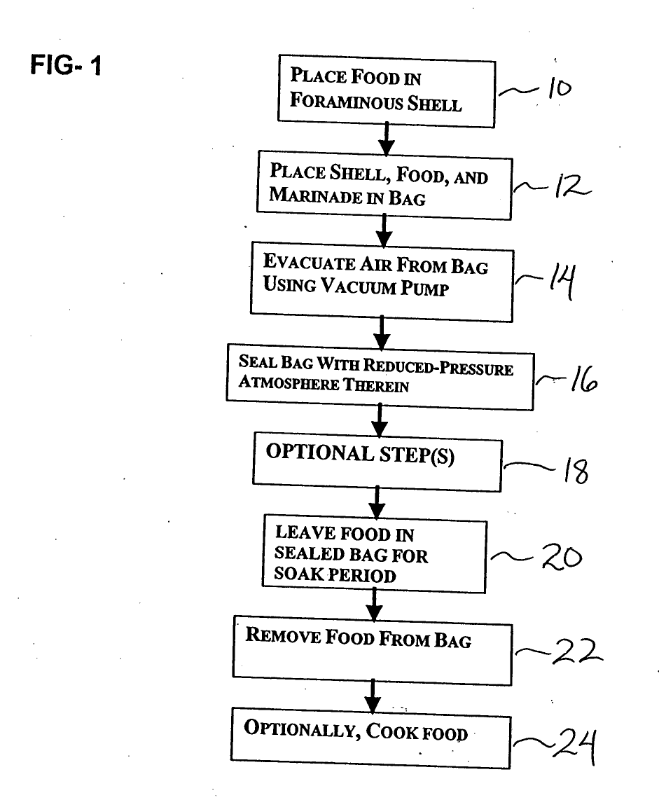

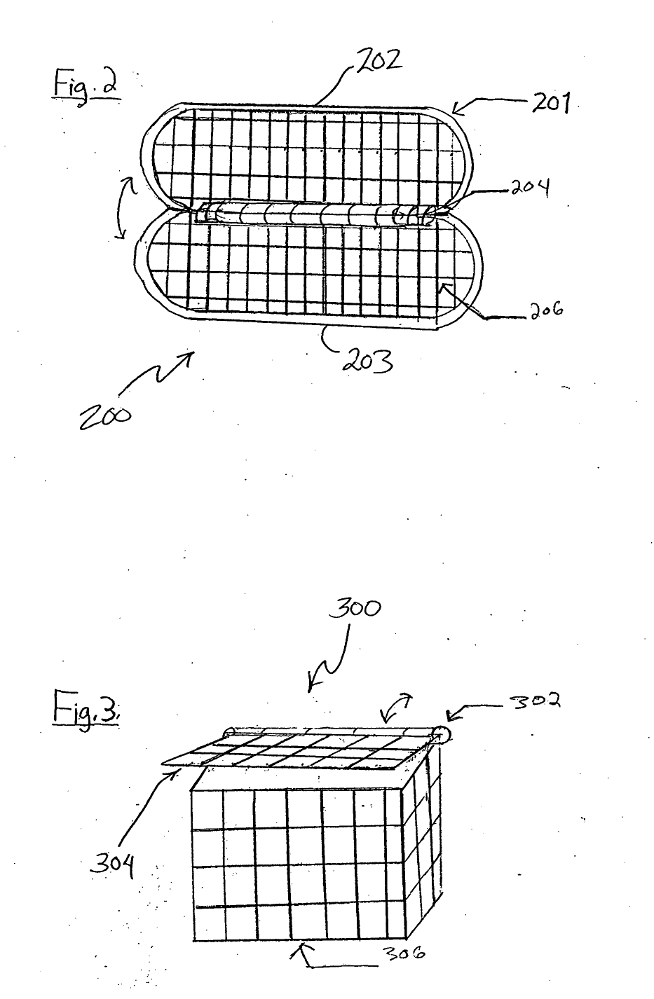

Referring now to FIG. 1 of the drawings, a flowchart illustrates steps in practicing a method according to a first illustrative embodiment of the present invention. The method may begin by placing one or more uncooked food items into a foraminous shell. The step of placing food into the shell is shown generally at 10 in FIG. 1. Various embodiments of the shell are shown at 200, 300, and 400 in FIGS. 2, 3, and 4, respectively. The food used may be raw meat, fish, vegetables, or any other foodstuff which may benefit from soaking in a marinade.

Next, the food, shell and a marinade are placed into a collapsible bag 500 (FIG. 5). The step of placing the food, shell and marinade into the bag 500 is shown generally at 12 in FIG. 1. The marinade used may be a liquid solution, emulsion or suspension, or may be a dry spice rub, if desired.

Air in the bag is then evacuated via a vacuum pump in the following step 14 and the bag is then sealed in the subsequent step 16, maintaining a reduced-pressure environment therein.

The user may then choose to vibrate, rotate, refrigerate, shake and/or tumble the bag 502 with the marinated food therein in one or more optional steps 18.

The method also includes a soak step 20, in which the food is left to soak in the marinade inside of the bag 500 for a soak period, which period may last for a time between 10 minutes and two or more hours, up to overnight in the refrigerator, as desired. The presence of the reduced-pressure atmosphere inside the bag makes the marinade enter the food quicker and more effectively than it would under normal atmospheric pressure.

At the user's discretion, the food is then removed from the bag and also from the shell 200, 300 or 400. If the food is one or more vegetables or is a food for which no cooking is required, the food may than be eaten. Alternatively, if the food is a raw meat, poultry or fish product which requires cooking, the food may be cooked after removal from the bag.

Food Marinating Kit

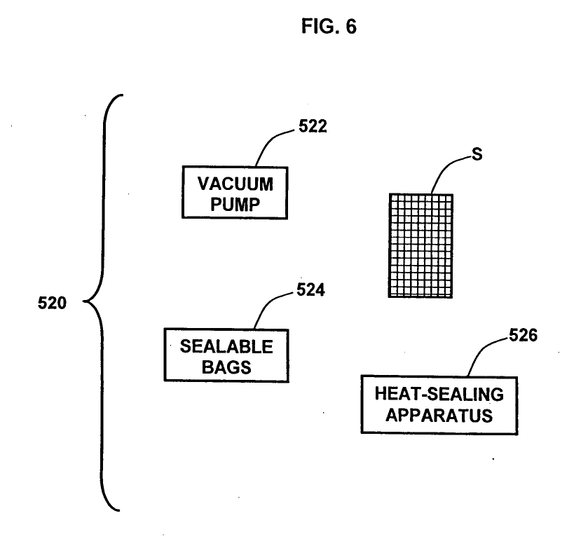

Referring now to FIG. 6, a food marinating kit is shown generally at 520. The kit 520 includes a number of supplies which may be used to practice the method according to the present invention. The kit 520 includes at least one foraminous shell S, which may be any of the shells 200, 300 or 400 as described herein, or which may be a foraminous shell of a different design. The kit 520 also includes a vacuum pump 52, which may be an electric pump or, alternatively, which may be a manually operated pump.

The kit 520 further includes a supply 524 of sealable bags 500 (FIG. 5) for receiving the shell S, along with a food product to be marinated and a liquid marinade therein. Optionally, the kit 520 may also include a heat-sealing apparatus 526 for sealing the bags after they have been evacuated with the shell and marinated food product therein.

Shell

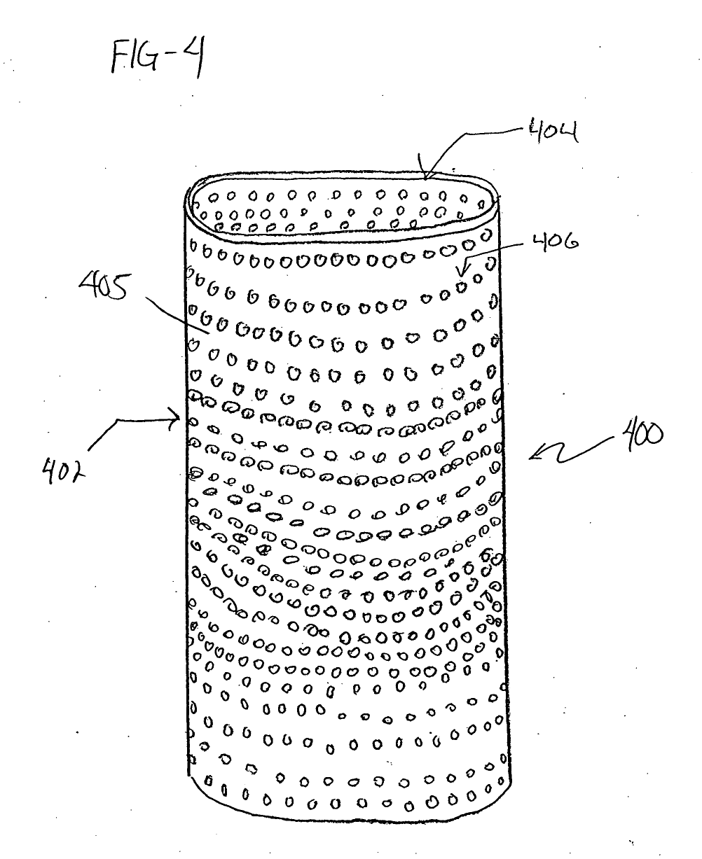

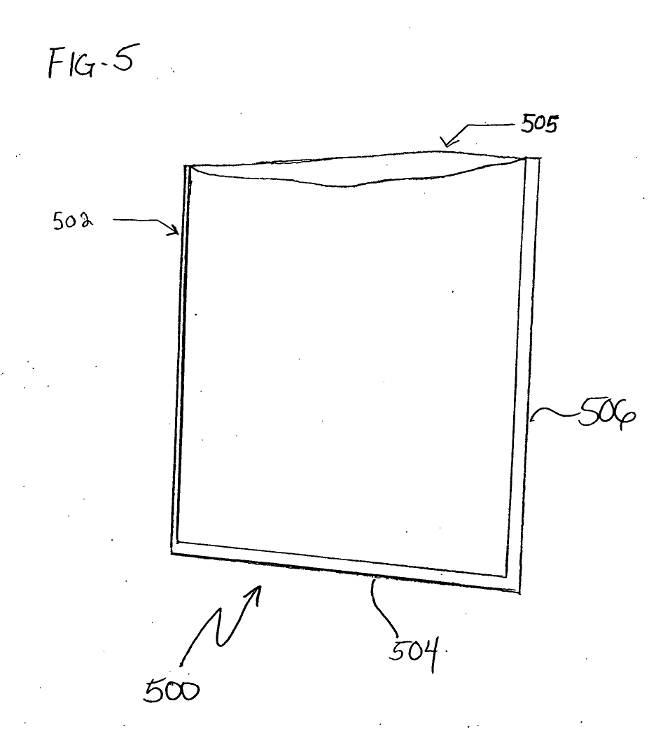

The shell is included in the kit to provide a structure which limits the extent to which the bag can compress around the food, so that the marinade has a chance to more effectively coat the food during the soak period. A number of alternate embodiments of the shell 200, 300 and 400 can be seen in FIGS. 2-4. The shell 200, 300 or 400 may be formed from metal or a relatively strong plastic. The shell may be in the shape of a flattened cylinder 400 open at the ends, and containing a multiplicity of perforations formed through a wall thereof (FIG. 4). Alternatively, the shell may be formed in a hinged clamshell shape 200, or in the shape of a wire-mesh box 300. Those in the art will realize that other, alternate shapes may be used for the shell.

Referring now to FIG. 2, it will be seen that the shell 200 may include an elliptical “clamshell”-type wire cage frame 201, including two symmetrical half-shell pieces 202, 203 interconnected by, and opened and closed by a connecting hinge 204. A porous mesh or screen 206 encloses and defines the outside shape of each of the two respective half-shell pieces 202, 203 of the frame 201.

The embodiment of the shell 300 shown in FIG. 3 depicts a generally rectangular box-shaped cage-like structure, in which the food is placed into the interior of the shell 300 via a hinged opening, in which a hinge 302 connects a lid portion 304 to a body portion 306 of the shell. The porous mesh, which encloses the frame in the embodiments of FIG. 2 and FIG. 3, may be made of a gauge and porosity selected by a manufaturer, although it should be sufficiently strong to prevent collapse of the shell when the bag 502 is evacuated.

The embodiment of the shell 400 depicted in FIG. 4 is a modified cylinder 402 which may have open ends 404 or closable ends. The shell 400 includes a wall 405 having a multiplicity of small holes 406 formed therethrough to permit passage of the marinade during use. The material making up the wall of the shell may be a strong plastic or metal having specified diameter holes 406 formed therein.

Bag

In FIG. 5 the aforementioned bag 500 is depicted with an opening 505, and either the remaining sides 502, 504, 506 are sealed with a heat-sealable resin, or the remaining sides are heat-welded together to form an airtight seal. The opening 505 is sealed after the shell, food, and marinade are disposed in the bag, and the air within the bag is evacuated using a vacuum pump.

Method Redux

In practicing the method according to an illustrative embodiment of the invention, one or more food items are placed within a foraminous shell. The shell can be made of any strong plastic, metal, or any other material suitable for storage of the food. The shell is of any shape that is conducive to storage of food. The shell may have a pivotally operable door at the top of the shell to allow for access to the inside of the shell to store and place the food before the marinating process occurs. The shell is then placed into a strong plastic bag, or any other sealable material that is conducive to storage of the food, along with a commercially available or homemade marinade of the user's choice. The air in the bag is then removed from the bag via a vacuum pump. This allows for a reduced-pressure environment to exist within the bag containing the food, marinade and, space for marinade circulation. The soak period may be in a range from 10 minutes to several hours or overnight, depending on user preference. During the soak period, the user may place the invention in the refrigerator, shake, tumble, vibrate, or rotate the bag with the food item(s) therein. Once the soak period is over the bag is opened up and the food is removed from the bag and cooked, served or stored.

Although the present invention has been described herein with respect to a number of specific illustrative embodiments, the foregoing description is intended to illustrate, rather than to limit the invention. Those skilled in the art will realize that many modifications of the preferred embodiment could be made which would be operable. All such modifications, which are within the scope of the claims, are intended to be within the scope and spirit of the present invention.

Having, thus, described the invention, what is claimed is:

1. A method of treating one or more food items to enhance the flavor of thereof, said method comprising the steps of:
placing one or more food items within a foraminous shell;
placing the shell into a plastic bag along with a flowable marinade;
removing air from within the bag using a vacuum pump to allow the bag to collapse around the shell, while still leaving some space in the shell around said food item for permitting the marinade to flow around said food items during a soak period;
resting the evacuated bag for a period of time in order to allow the marinade to penetrate the food; and
opening the bag, and removing said food from the shell.

2. The method of claim 1, wherein said shell is made of a strong plastic or metal material.

3. The method of claim 1, wherein said shell is formed in a shape corresponding to said food items.

4. The method of claim 1, wherein said shell has a swivel opening at a top end thereof to allow for access to the inside of said shell.

5. The method of claim 1, wherein said bag is made of a flexible plastic.

6. The method of claim 1, wherein the bag is refrigerated during the resting step.

7. A food marinating kit, comprising:
at least one foraminous shell;
a vacuum pump; and
a bag supply comprising a plurality of sealable bags.

8. The food marinating kit of claim 7, further comprising a heat-sealing apparatus for sealing a bag after it has been evacuated with the foraminous shell and a marinated food product therein.
